(19) United States
(12) Patent Application Publication
(10) Pub. No.: US 2025/0170834 A1
(43) Pub. Date: May 29, 2025

(54) MEDIUM PROCESSING APPARATUS AND IMAGE FORMING SYSTEM INCORPORATING SAME

(71) Applicant: Takuma Yazaki, Kanagawa (JP)

(72) Inventor: Takuma Yazaki, Kanagawa (JP)

(73) Assignee: Ricoh Company, Ltd., Tokyo (JP)

(21) Appl. No.: 18/950,892

(22) Filed: Nov. 18, 2024

(30) Foreign Application Priority Data
Nov. 28, 2023 (JP) 2023-200759

(51) Int. Cl. B41J 11/00

(52) U.S. Cl. CPC B41J 11/005; B41J 11/007

(57) ABSTRACT

A medium processing apparatus includes a stacker, a liquid applier, a post-processor, an ejector, a guide, and circuitry. The stacker stacks multiple media including a medium. The liquid applier applies liquid to the multiple media. The post-processor performs a given process on the multiple media. The ejector ejects the multiple media on which the given process is performed by the post-processor. The guide opens and closes a conveyance passage. The circuitry is to control the guide to open the conveyance passage to a first opening amount, and to control the guide to open the conveyance passage a second opening amount smaller than the first opening amount to control the liquid applier to apply the liquid to the medium.

### CROSS-REFERENCE TO RELATED APPLICATION

This patent application is based on and claims priority pursuant to 35 U.S.C. § 119(a) to Japanese Patent Application No. 2023-200759, filed on Nov. 28, 2023, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Background Art

Various medium processing apparatuses are known that include: a conveyor that conveys a sheet-like medium on which an image is formed by an image forming apparatus; a stacking tray that stacks multiple media conveyed by the conveyor; a binder that binds the multiple media stacked on the stacking tray in a bundle; and an ejection tray that ejects the bundle of media bound by the binder.

In such a medium processing apparatus, in order to stack the multiple media on the stacking tray, there is a technique of separating a pair of rollers constituting the conveyor to make an opening of a conveyance passage of the media from the stacking tray to the ejection tray.

However, in the configuration of the medium processing apparatus known in the art, there is a possibility that foreign matter is mixed from the ejection tray side to the binder side through the opening of the conveyance passage. As a result, the bundle of media may not be properly bound or the components may be damaged.

### SUMMARY

Embodiments of the present disclosure described herein provide a novel medium processing apparatus includes a stacker, a liquid applier, a post-processor, an ejector, a guide, and circuitry. The stacker stacks multiple media including a medium. The liquid applier applies liquid to at least one of the multiple media on the stacker. The post-processor performs a given process on the multiple media to which the liquid has been applied by the liquid applier. The ejector stacks the multiple media on which the given process is performed by the post-processor. The guide opens and closes a conveyance passage to guide the medium from the stacker to the ejector. The circuitry is to control the guide to open the conveyance passage to a first opening amount to stack the medium on the stacker, and control the guide to open the conveyance passage to a second opening amount smaller than the first opening amount to control the liquid applier to apply the liquid to the medium.

Further, embodiments of the present disclosure described herein provide an image forming system including an image forming apparatus to form an image on a medium, and the above-described medium processing apparatus.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating a general arrangement of an image forming system;

FIG. 2 is a diagram illustrating an internal configuration of a post-processing apparatus according to a first embodiment;

FIG. 3 is a schematic diagram of an edge binder as viewed from an upstream side in a conveyance direction;

FIG. 4 is a schematic diagram of the edge binder as viewed from a liquid applier side in a main scanning direction;

FIGS. 5A and 5B are schematic diagrams illustrating a configuration of a crimper;

FIG. 6 is a diagram illustrating a modification of the edge binder;

FIGS. 7A, 7B, and 7C are diagrams each illustrating a liquid application crimper according to the modification of the edge binder;

FIGS. 8A, 8B, and 8C are diagrams illustrating a liquid application operation and a crimp binding operation performed by the liquid application crimper of FIGS. 7A, 7B, and 7C;

FIG. 9 is a schematic diagram of a staple binder as viewed from the upstream side in the conveyance direction;

FIG. 10 is a schematic diagram of a modification of the staple binder as viewed from the upstream side in the conveyance direction;

FIGS. 11A and 11B are enlarged views of a main part around an internal tray;

FIG. 12 is a hardware configuration diagram illustrating a control block that controls the post-processing apparatus according to the first embodiment;

FIG. 13 is a flowchart of a binding by the edge binder;

FIGS. 14A, 14B, and 14C are diagrams illustrating positions of the liquid applier and the crimper during the binding by the edge binder;

FIG. 15 is a flowchart of a binding in which foreign matter is prevented from being mixed in which foreign matter is prevented from being mixed; and

FIGS. 16A and 16B are diagrams illustrating states of a conveyance roller pair in steps S1501 and S1503 of FIG. 15.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

A description is given below of an image forming system 1 according to the present invention, with reference to the drawings.

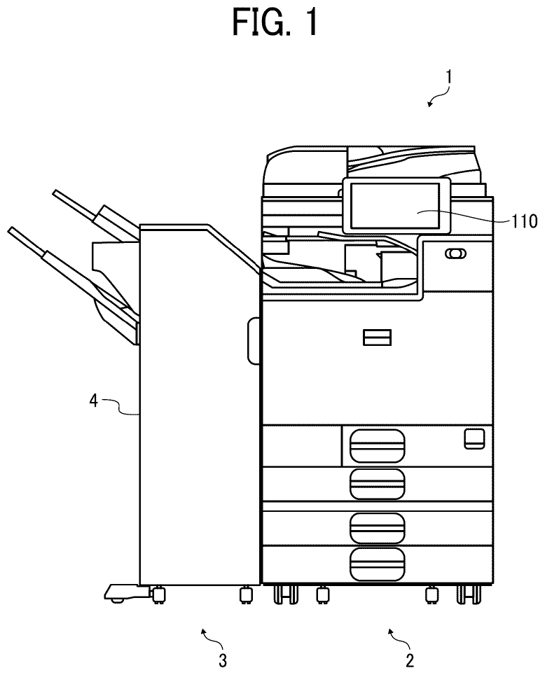

FIG. 1 is a diagram illustrating a general arrangement of the image forming system 1.

The image forming system 1 has a function of forming an image on a sheet P (a sheet-shaped medium) and performing post-processing on the sheet P on which the image is formed. As illustrated in FIG. 1, the image forming system 1 includes an image forming apparatus 2, and a post-processing apparatus 3 (medium processing apparatus) according to the present invention.

The image forming apparatus 2 forms an image on the sheet P and ejects the sheet P having the image to the post-processing apparatus 3. The image forming apparatus 2 includes a tray that accommodates the sheet P, a conveyor that conveys the sheet P accommodated in the tray, and an image former that forms an image on the sheet P conveyed by the conveyor. The image former may be of an inkjet type that forms an image with ink or may be of an electrophotographic type that forms an image with toner. Since the configuration of the image forming apparatus 2 is already known, detailed description thereof is omitted.

### First Embodiment of Post-Processing Apparatus

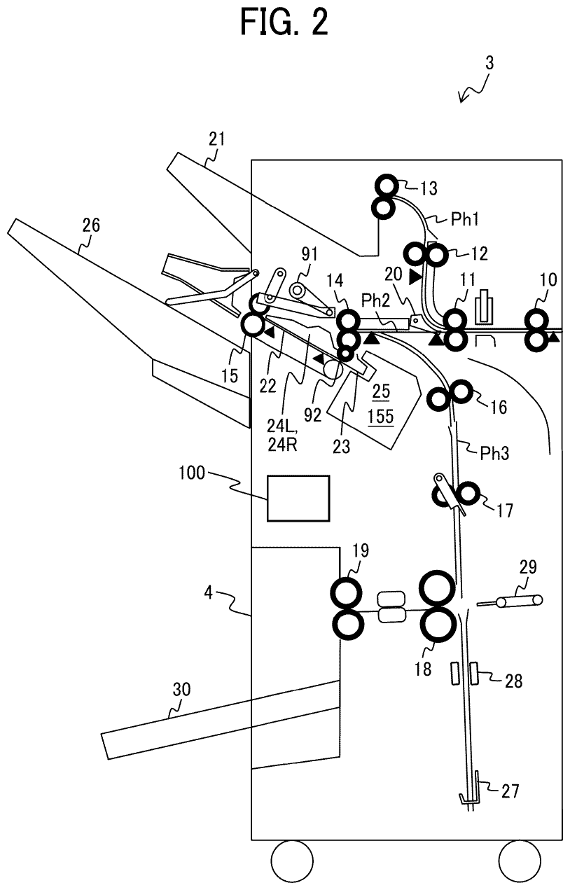

FIG. 2 is a diagram illustrating an internal configuration of the post-processing apparatus 3 according to a first embodiment.

The post-processing apparatus 3 performs a post-processing (given process) on the sheet P on which an image has been formed by the image forming apparatus 2. An example of the post-processing according to the present embodiment is a binding as a “crimp binding” that binds, without a staple, a bundle (sheet bundle) of multiple sheets P on which images have been formed. Another example of the post-processing according to the present embodiment is a binding as a “staple binding” that binds, with a staple, a bundle (sheet bundle) of multiple sheets P on which images have been formed. In the following description, a bundle (media bundle) of multiple sheets P is referred to as a “sheet bundle Pb”.

More particularly, the “crimp binding” according to the present embodiment is a process called “crimp binding” that applies pressure to a binding position corresponding to a part of the sheet bundle Pb to deform (pressure-deform) the binding position and binds the sheet bundle Pb. The binding that can be executed by the post-processing apparatus 3 includes edge binding and saddle stitching. The edge binding is a process to bind an end portion of the sheet bundle Pb. The saddle stitching is a process to bind a center portion of the sheet bundle Pb.

The post-processing apparatus 3 includes conveyance roller pairs 10 to 19 (conveyor) and a switching member 20. The conveyance roller pairs 10 to 19 convey, inside the post-processing apparatus 3, the sheet P supplied from the image forming apparatus 2. More particularly, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3.

The first conveyance passage Ph1 is a passage extending to an ejection tray 21 from a supply port for the sheet P from the image forming apparatus 2. The second conveyance passage Ph2 is a passage branching from the first conveyance passage Ph1 between the conveyance roller pairs 11 and 14 in a conveyance direction and extending to an ejection tray 26 via an internal tray 22. The third conveyance passage Ph3 is a passage branching from the first conveyance passage Ph1 between the conveyance roller pairs 11 and 14 in the conveyance direction and extending to an ejection tray 30.

The switching member 20 is disposed at a branching position of the first conveyance passage Ph1 and the second conveyance passage Ph2. The switching member 20 is enabled to change its position between a first position and a second position. In the first position, the sheet P is ejected to the ejection tray 21 through the first conveyance passage Ph1. In the second position, the sheet P conveyed through the first conveyance passage Ph1 is guided to the second conveyance passage Ph2. At a timing when a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes multiple sensors that detects positions of the sheet P in the first conveyance passage Ph1, the second conveyance passage Ph2, and the third conveyance passage Ph3. Each of the multiple sensors are indicated by a black triangle mark in FIG. 2.

The post-processing apparatus 3 includes the ejection tray 21. The sheet P ejected through the first conveyance passage Ph1 is stacked on the ejection tray 21. Among the sheets P supplied from the image forming apparatus 2, the sheets P not subjected to a binding are ejected to the ejection tray 21.

The post-processing apparatus 3 further includes the internal tray 22 serving as a stacker, an end fence 23, side fences 24L and 24R, an edge binder 25, a staple binder 155, the ejection tray 26, a hitting roller 91, and a return roller 92. The internal tray 22, the end fence 23, the side fences 24L and 24R, the edge binder 25, the staple binder 155, the hitting roller 91, and the return roller 92 perform the edge binding on the sheet bundle Pb including multiple sheets P conveyed through the second conveyance passage Ph2. Among the sheets P supplied from the image forming apparatus 2, the sheet bundle Pb subjected to the edge binding is ejected to the ejection tray 26.

The “edge binding” includes “parallel binding”, “oblique binding”, and “vertical binding”. The “parallel binding” is a process to perform a binding on the sheet bundle Pb along one side of the sheet bundle Pb parallel to a main scanning direction. The “oblique binding” is a process to perform a binding on a corner of the sheet bundle Pb. The “vertical binding” is a process to perform binding on the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction” of the sheet P. In other words, the “conveyance direction” herein corresponds to a direction in which the sheet P that has been ejected from the image forming apparatus 2 is moved toward the ejection tray 26 by, for example, the conveyance roller pair 10 and then is moved toward the end fence 23 by the conveyance roller pair 15. A direction that is orthogonal to the conveyance direction and a thickness direction of the sheet P is defined as a “main scanning direction” or a “width direction of the sheet P”.

The internal tray 22 is disposed downstream from the conveyance roller pair 15 in the conveyance direction. The multiple sheets P that are sequentially conveyed through the second conveyance passage Ph2 is temporarily stacked on the internal tray 22 serving as a stacker or a stacking tray. The internal tray 22 according to the present embodiment is inclined downward toward the downstream side in the conveyance direction. The hitting roller 91 is rotatably held by the distal end of a pivot arm above the internal tray 22. The pivot arm pivots, whereby the hitting roller 91 comes into contact with and separates from the uppermost sheet P stacked on the internal tray 22. The return roller 92 is disposed above the internal tray 22, downstream from the hitting roller 91 in the conveyance direction.

When the pivot arm pivots in a direction in which the hitting roller 91 is separated from the internal tray 22, the sheet P conveyed in the conveyance direction by the conveyance roller pair 15 enters the internal tray 22. In this state, when the pivot arm pivots in a direction in which the hitting roller 91 is brought close to the internal tray 22, the hitting roller 91 comes into contact, from above, with the sheet P conveyed onto the internal tray 22 by the conveyance roller pair 15. The sheet P brought into contact with the hitting roller 91 is separated from the conveyance roller pair 15 and stacked on the internal tray 22. The return roller 92 rotates in contact with the upper surface of the sheet P stacked on the internal tray 22 to guide the sheet P toward the end fence 23.

The end fence 23 is disposed downstream from the internal tray 22 in the conveyance direction. The end fence 23 is enabled to move in the main scanning direction along the surface of the sheet P or the sheet bundle Pb stacked on the internal tray 22. The end fence 23 comes into contact with the downstream end in the conveyance direction of the sheet P or the sheet bundle Pb stacked on the internal tray 22 to align the downstream ends in the conveyance direction of the multiple sheets P of the sheet bundle Pb. The side fences 24L and 24R are disposed on both sides of the internal tray 22 in the main scanning direction. The side fences 24L and 24R are enabled to move in the main scanning direction. The side fences 24L and 24R come in contact with both ends in the main scanning direction of the sheet P or the sheet bundle Pb stacked on the internal tray 22 to align the ends in the main scanning direction of the multiple sheets P of the sheet bundle Pb.

The edge binder 25 and the staple binder 155 are disposed downstream from the internal tray 22 in the conveyance direction. The edge binder 25 and the staple binder 155 are enabled to independently move in the main scanning direction along the surface of the sheet P or the sheet bundle Pb stacked on the internal tray 22. The edge binding is performed on the end portion of the sheet bundle Pb aligned by the end fence 23 and the side fences 24L and 24R. The sheet bundle Pb subjected to the crimp binding is ejected to the ejection tray 26 by the conveyance roller pair 15.

The post-processing apparatus 3 further includes an end fence 27, a saddle binder 28, a sheet folding blade 29, and the ejection tray 30. The end fence 27, the saddle binder 28, and the sheet folding blade 29 perform the saddle stitching on the sheet bundle Pb including the multiple sheets P conveyed through the third conveyance passage Ph3. Among the sheets P supplied from the image forming apparatus 2, the sheet bundle Pb subjected to the saddle stitching is ejected to the ejection tray 30.

The end fence 27 aligns positions in the conveyance direction of the multiple sheets P sequentially conveyed through the third conveyance passage Ph3. The end fence 27 is enabled to move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb stacked on the end fence 27 at the folding position and causes the conveyance roller pair 18 to nip the sheet bundle Pb. The conveyance roller pairs 18 and 19 eject the sheet bundle Pb subjected to the saddle stitching to the ejection tray 30.

### Detailed Description of Edge Binder

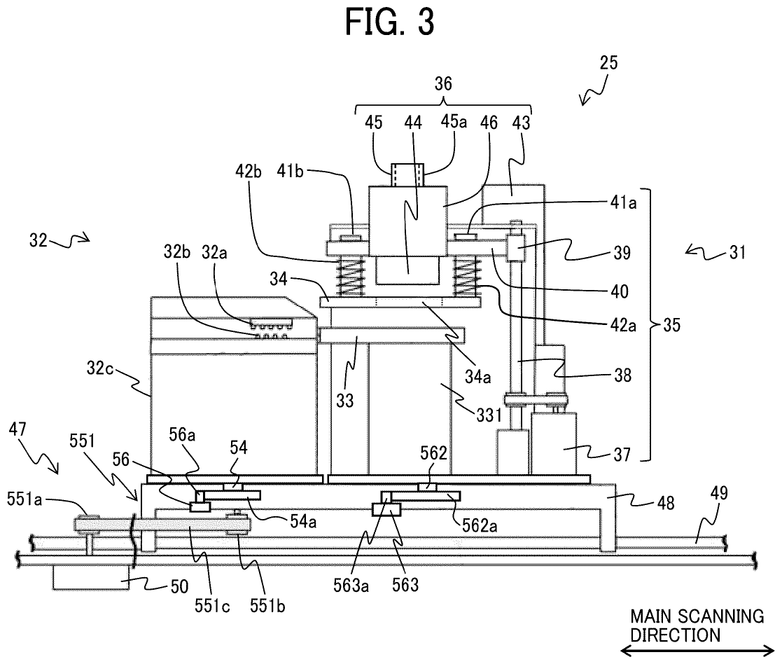

FIG. 3 is a schematic diagram of the edge binder 25 that performs liquid application and crimp binding as viewed from an upstream side in the conveyance direction.

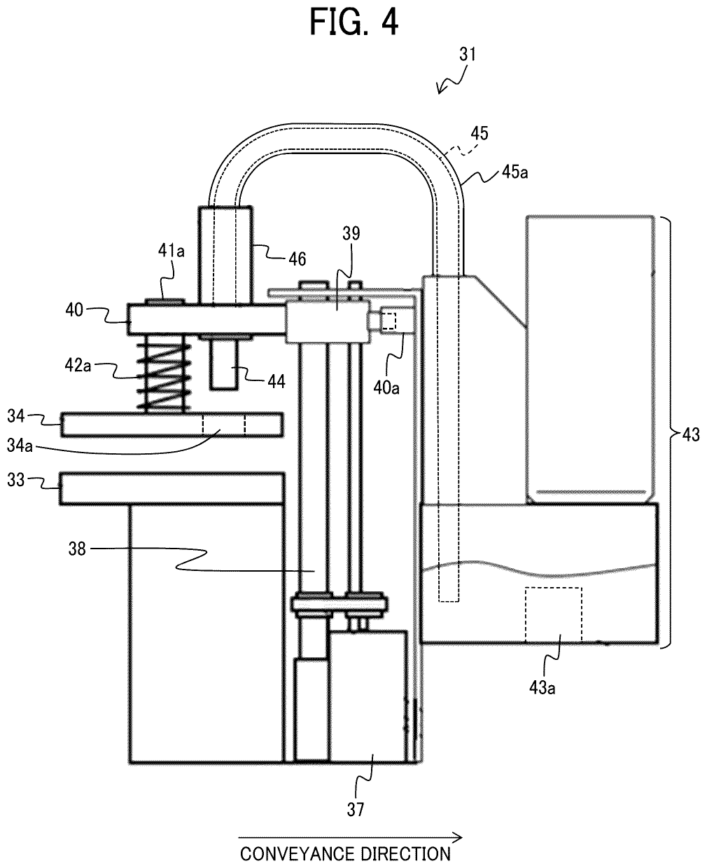

FIG. 4 is a schematic diagram of the edge binder 25 as viewed from a liquid applier 31 side in the main scanning direction.

As illustrated in FIGS. 3 and 4, the edge binder 25 includes the liquid applier 31 and a crimper 32. The liquid applier 31 executes an operation related to liquid application. The crimper 32 serves as a post-processing device and executes the crimp binding. The liquid applier 31 and the crimper 32 are disposed downstream from the internal tray 22 in the conveyance direction and adjacent to each other in the main scanning direction.

The liquid applier 31 applies a liquid that is stored in a liquid storage tank 43 to the sheet P or the sheet bundle Pb stacked on the internal tray 22. In the following description, the application of liquid to the sheet P or the sheet bundle Pb may be referred to as “liquid application” while a process to apply liquid may be referred to as “liquid application process”.

The liquid stored in the liquid storage tank 43 for performing liquid application is more specifically a liquid having, as a main component, a liquid state of a compound of hydrogen and oxygen represented by the chemical formula “H2O”. The compound is at any temperature as long as it is in the liquid state. For example, the compound may be so-called warm water or hot water. The compound is not limited to pure water. The compound may be purified water or may contain ionized salts. The metal ion content ranges from so-called soft water to ultrahard water. In other words, the compound is at any hardness.

The liquid may include an additive in addition to the main component. The liquid may include residual chlorine used as tap water. Preferably, for example, the liquid may include, as an additive, a colorant, a penetrant, a pH adjuster, a preservative such as phenoxyethanol, a drying inhibitor such as glycerin, or the like. Since water is used as a component of ink used for inkjet printers or ink used for water-based pens, such ink may be used for the “liquid application”.

The liquid is not limited to the specific examples described above. The liquid may be “water” in a broad sense such as hypochlorous acid water or an ethanol aqueous solution diluted for disinfection. However, tap water may be used simply to enhance the binding strength after the binding because tap water is easy to obtain and store. A liquid including water as a main component as exemplified above can enhance the binding strength of the sheet bundle Pb, as compared with a liquid of which the main component is not water.

### Configurations of Liquid Applier and Crimper

The liquid applier 31 and the crimper 32 are enabled to move together in the main scanning direction by driving force transmitted from an edge binder movement motor 50. A position (liquid application position) at which liquid application is performed on the sheet P or the sheet bundle Pb by the liquid applier 31 corresponds to a position (crimp binding position) to which crimp binding by the crimper 32 is planned to be performed. Thus, in the following description, the liquid application position and the crimp binding position are denoted by the same reference sign.

As illustrated in FIGS. 3 and 4, the liquid applier 31 is enabled to move in the main scanning direction together with the crimper 32 by the driving force transmitted from the edge binder movement motor 50. The liquid applier 31 includes a lower pressure plate 33 serving as a stacker or a stacking table for the sheet P or the sheet bundle Pb, an upper pressure plate 34, a liquid-applier movement assembly 35, and a liquid application assembly 36. The components of the liquid applier 31 (the lower pressure plate 33, the upper pressure plate 34, the liquid-applier movement assembly 35, and the liquid application assembly 36) are held by a liquid application frame 31a and a base 48.

The lower pressure plate 33 and the upper pressure plate 34 are disposed downstream from the internal tray 22 in the conveyance direction. The sheet P or the sheet bundle Pb stacked on the internal tray 22 is also stacked on the lower pressure plate 33. The lower pressure plate 33 is disposed on a lower pressure plate holder 331. The upper pressure plate 34 is enabled to move in the thickness direction of the sheet P or the sheet bundle Pb at a position where the upper pressure plate 34 faces the sheet P or the sheet bundle Pb stacked on the internal tray 22. In other words, in a space where the lower pressure plate 33 and the upper pressure plate 34 face each other, the lower pressure plate 33 and the upper pressure plate 34 are disposed to face each other in the thickness direction of the sheet P or the sheet bundle Pb so as to sandwich the sheet P or the sheet bundle Pb stacked on the internal tray 22. In the following description, the thickness direction of the sheet P or the sheet bundle Pb may be referred to simply as “thickness direction”. The upper pressure plate 34 has a through hole 34a penetrating in the thickness direction at a position where the through hole 34a faces an end of a liquid application member 44 held via a joint 46 attached to a base plate 40.

The liquid-applier movement assembly 35 moves the upper pressure plate 34, the base plate 40, and the liquid application member 44 in the thickness direction of the sheet P or the sheet bundle Pb. The liquid-applier movement assembly 35 according to the present embodiment moves the upper pressure plate 34, the base plate 40, and the liquid application member 44 in conjunction with each other by a single liquid applier movement motor 37. The liquid-applier movement assembly 35 includes, for example, the liquid applier movement motor 37, a trapezoidal screw 38, a nut 39, the base plate 40, columns 41a and 41b, and coil springs 42a and 42b.

The liquid applier movement motor 37 generates driving force to move the upper pressure plate 34, the base plate 40, and the liquid application member 44. The trapezoidal screw 38 extends in the thickness direction of the sheet P or the sheet bundle Pb and is attached to the liquid application frame 31a so as to be rotatable in the forward and reverse directions. The trapezoidal screw 38 is coupled to an output shaft of the liquid applier movement motor 37 via, for example, a pulley and a belt. The nut 39 is screwed to the trapezoidal screw 38. The trapezoidal screw 38 is rotated in the forward and reverse directions by the driving force transmitted from the liquid applier movement motor 37, whereby the nut 39 reciprocates on the trapezoidal screw 38.

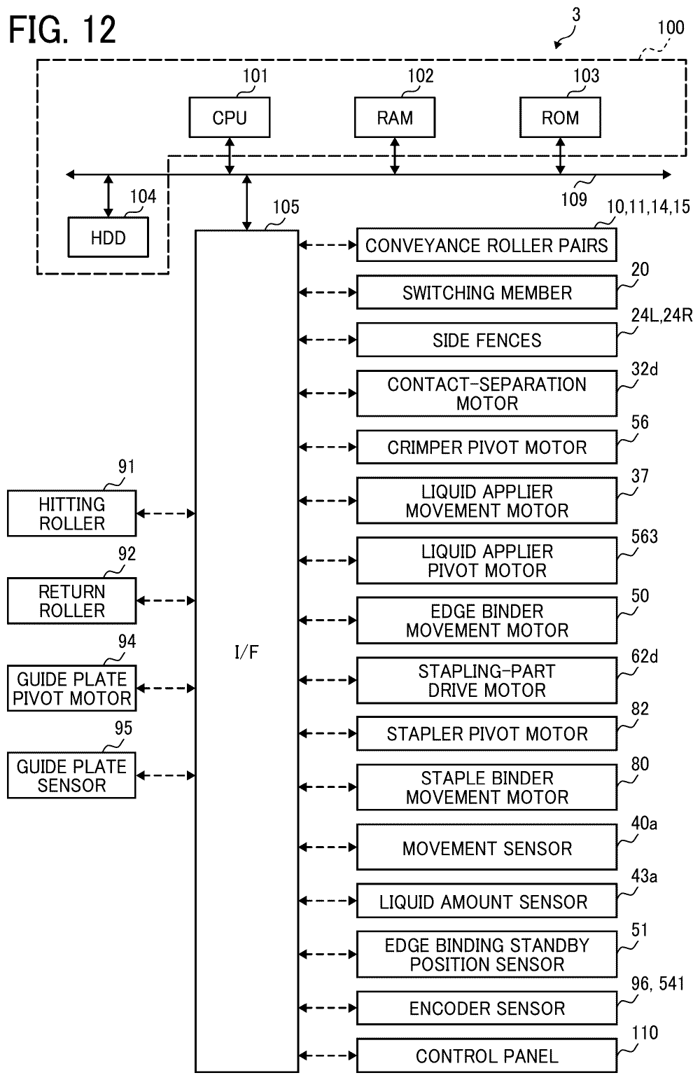

The base plate 40 is disposed at a position apart from the upper pressure plate 34. The base plate 40 holds the liquid application member 44 with the end of the liquid application member 44 projecting from the base plate 40 toward the upper pressure plate 34. The base plate 40 is coupled to the trapezoidal screw 38 via the nut 39, and is enabled to reciprocate along the trapezoidal screw 38 by rotation of the trapezoidal screw 38 in the forward and reverse directions. A position of the base plate 40 in the thickness direction of the sheet P or the sheet bundle Pb is detected by a movement sensor 40a (see FIG. 12). The columns 41a and 41b project from the base plate 40 toward the upper pressure plate 34 around the end of the liquid application member 44. The columns 41a and 41b is enabled to move relative to the base plate 40 in the thickness direction. The columns 41a and 41b hold the upper pressure plate 34 by ends on the lower pressure plate 33 side. Ends of the columns 41a and 41b on the opposite side from the lower pressure plate 33 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 performs liquid application to the sheet P or the sheet bundle Pb stacked on the internal tray 22. More particularly, the liquid application assembly 36 brings the end of the liquid application member 44 into contact with the sheet P or the sheet bundle Pb to perform the liquid application to at least one sheet P constituting the sheet bundle Pb. The liquid application assembly 36 includes the liquid storage tank 43, the liquid application member 44, a liquid supplier 45, and the joint 46.

The liquid storage tank 43 stores the liquid to be supplied to the sheet P or the sheet bundle Pb. An amount of liquid stored in the liquid storage tank 43 is detected by a liquid amount sensor 43a. The liquid application member 44 applies the liquid stored in the liquid storage tank 43 to the sheet P or the sheet bundle Pb. The liquid application member 44 is attached to the base plate 40 with the end of the liquid application member 44 oriented toward the upper pressure plate 34 side. The liquid application member 44 includes a porous material having a relatively high liquid absorption or a fiber material that can absorb liquid by capillary action. The liquid application member 44 is not limited to a particular kind, provided that the liquid application member 44 includes a material having a property of absorbing and holding the liquid and has a property of being crushed according to a pressing force applied in a state where the liquid application member 44 is in contact with the sheet P. For example, the liquid application member 44 may be a foam material such as a sponge or a fiber that can absorb liquid by capillary action.

The liquid supplier 45 is an elongated member having a base end immersed in the liquid stored in the liquid storage tank 43 and a distal end coupled to the liquid application member 44. Like the liquid application member 44, for example, the liquid supplier 45 includes a material having a relatively high liquid absorption. Accordingly, the liquid is absorbed from the base end of the liquid supplier 45 and travels through the liquid supplier 45 by capillary action to be supplied to the liquid application member 44. Although the liquid application member 44 and the liquid supplier 45 are separately disposed in the embodiment described above, the liquid application member 44 and the liquid supplier 45 may be integrated together with materials having like properties. In this case, like the embodiment described above, the liquid stored in the liquid storage tank 43 is absorbed by capillary action. This case further attains cost reduction.

A protector 45a is an elongated cylindrical body (for example, a tube) that is fitted around the liquid supplier 45. The protector 45a prevents the liquid absorbed by the liquid supplier 45 from leaking or evaporating. Each of the liquid supplier 45 and the protector 45a includes a flexible material. The joint 46 fixes the liquid application member 44 to the base plate 40. Accordingly, the liquid application member 44 keeps projecting from the base plate 40 toward the upper pressure plate 34 side with the end of the liquid application member 44 facing downward even when the liquid application member 44 is moved by the liquid-applier movement assembly 35.

A liquid-applier shaft 562 provided with a drive transmission gear 562a is fixed to a bottom face of the liquid application frame 31a that holds the components of the liquid applier 31. The liquid-applier shaft 562 and the drive transmission gear 562a are held by the base 48 on which the liquid application frame 31a is disposed, so as to be rotatable in the forward and reverse directions. The drive transmission gear 562a engages with an output gear 563a of a liquid applier pivot motor 563. The liquid applier 31 is enabled to rotate in the forward and reverse directions about the liquid-applier shaft 562 on the base 48 by driving force transmitted from the liquid applier pivot motor 563 to the liquid-applier shaft 562 via the output gear 563a and the drive transmission gear 562a.

The crimper 32 (post-processing device) sandwiches, with serrate upper crimping teeth 32a and serrate lower crimping teeth 32b, at least a part (in other words, the liquid application position) of the sheet bundle Pb to which the liquid is applied by the liquid applier 31 to press and deform the at least the part of the sheet bundle Pb. Thus, the crimper 32 binds the sheet bundle Pb. In the following description, such a binding way in which the upper crimping teeth 32a and the lower crimping teeth 32b sandwich and press the sheet bundle Pb to deform at least a part of the sheet bundle Pb may be referred to as “crimp binding”. In other words, the crimper 32 can bind the sheet bundle Pb without binding materials such as staples. The components of the crimper 32 (the upper crimping teeth 32a and the lower crimping teeth 32b) are disposed on a crimping frame 32c.

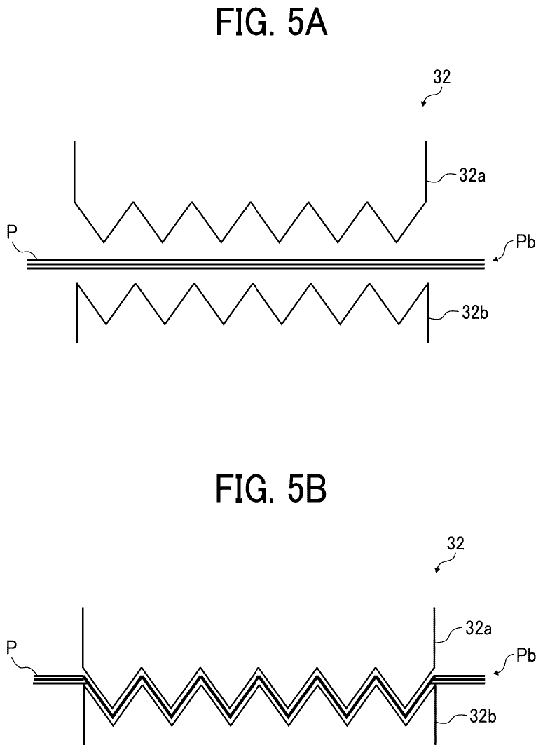

FIGS. 5A and 5B are schematic diagrams illustrating a configuration of the crimper 32.

As illustrated in FIGS. 5A and 5B, the crimper 32 includes a pair of binding teeth (the upper crimping teeth 32a and the lower crimping teeth 32b). The upper crimping teeth 32a and the lower crimping teeth 32b are disposed to face each other in the thickness direction of the sheet bundle Pb so as to sandwich the sheet bundle Pb stacked on the internal tray 22. The upper crimping teeth 32a and the lower crimping teeth 32b have respective serrate faces facing each other. The serrate face of each of the upper crimping teeth 32a and the lower crimping teeth 32b includes recessed portions and projecting portions alternately formed. The recessed portions and the projecting portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of the contact-separation motor 32d (see FIG. 12).

In a process of supplying the multiple sheets P included in the sheet bundle Pb to the internal tray 22, the upper crimping teeth 32a and the lower crimping teeth 32b are separated from each other as illustrated in FIG. 5A. When all the sheets P constituting the sheet bundle Pb are stacked on the internal tray 22, the upper crimping teeth 32a and the lower crimping teeth 32b are engaged with each other to press and deform the sheet bundle Pb in the thickness direction as illustrated in FIG. 5B. As a result, the sheet bundle Pb stacked on the internal tray 22 is subjected to the crimp binding. The sheet bundle Pb subjected to the crimp binding is ejected to the ejection tray 26 by the conveyance roller pair 15.

The configuration of the crimper 32 is not limited to the configuration according to the form of the embodiment described above, provided that the upper crimping teeth 32a and the lower crimping teeth 32b constituting the crimping assembly are engaged with each other. For example, a link assembly type crimping assembly (for example, disclosed in Japanese Patent No. 6057167) may be used that performs crimping and separation operations of the upper crimping teeth 32a and the lower crimping teeth 32b by using a drive source that perform only forward rotation or forward and reverse rotation and a link assembly, or a linear motion type crimping assembly may be used that linearly performs crimping (approaching) and separation operations of the upper crimping teeth 32a and the lower crimping teeth 32b by a screw assembly that converts rotational motion of the drive source in the forward and reverse directions into linear reciprocating motion.

A crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a engages with an output gear 56a of a crimper pivot motor 56. The crimper 32 is enabled to rotate in the forward and reverse directions about the crimper shaft 54 on the base 48 by driving force transmitted from the crimper pivot motor 56 to the crimper shaft 54 via the output gear 56a and the drive transmission gear 54a.

As illustrated in FIG. 3, the edge binder 25 includes an edge-binder movement assembly 47. The edge-binder movement assembly 47 moves the edge binder 25 (in other words, the liquid applier 31 and the crimper 32) in the main scanning direction along a downstream end, in the conveyance direction of the sheet P stacked on the internal tray 22. The edge-binder movement assembly 47 includes, for example, the base 48, a guide shaft 49, the edge binder movement motor 50, and a driving force transmission assembly 551.

The liquid applier 31 and the crimper 32 are attached to the base 48 so as to be adjacent to each other in the main scanning direction. The guide shaft 49 extends in the main scanning direction, downstream from the internal tray 22 in the conveyance direction. The guide shaft 49 supports the base 48 movably in the main scanning direction. The edge binder movement motor 50 generates the driving force to move the edge binder 25. The driving force transmission assembly 551 transmits the driving force of the edge binder movement motor 50 to the base 48 via pullies 551a and 551b and a timing belt 551c. As a result, the liquid applier 31 and the crimper 32 integrated together by the base 48 move in the main scanning direction along the guide shaft 49.

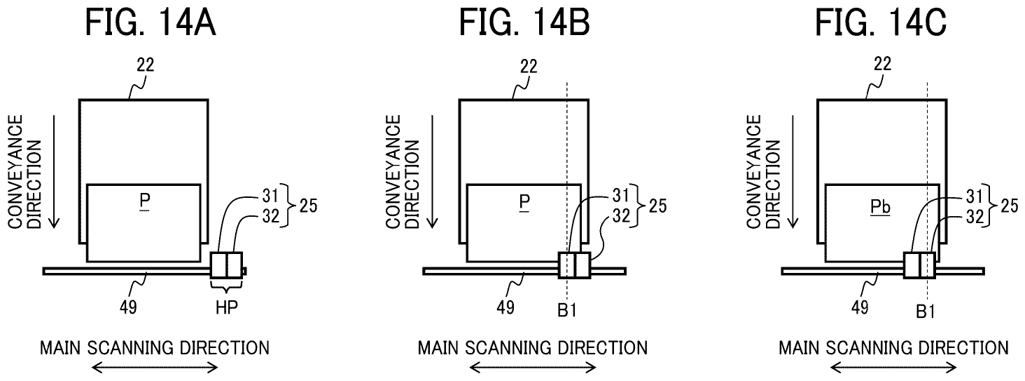

In other words, as illustrated in FIG. 14A, a standby position HP is a position away from the sheet P stacked on the internal tray 22 in the width direction. As illustrated in FIGS. 14B to 14C, the liquid applier 31 and the crimper 32 can move along the guide shaft 49 to a position where the liquid applier 31 and the crimper 32 can face the sheet P stacked on the internal tray 22 in the thickness direction of the sheet P.

The edge binder movement motor 50 according to the present embodiment is, for example, a servo motor that can stop the edge binder 25 at a target position (a binding position B1) without returning the edge binder 25 to an origin position (for example, the standby position HP described later) each time the edge binder 25 is moved.

The post-processing apparatus 3 further includes an edge binding standby position sensor 51 (For example, a light shielding type optical sensor. See FIG. 12) that detects arrival of the edge binder 25 at the standby position HP (see FIGS. 14A, 14B, and 14C), and an encoder sensor 541 (see FIG. 12) attached to an output shaft of the edge binder movement motor 50. A controller 100, which will be described later, detects the arrival of the edge binder 25 at the standby position HP, on the basis of a detection result by an edge-binding standby position sensor 44a. The controller 100 also counts pulse signals output from the encoder sensor 541 to ascertain a current position of the edge binder 25 moved from the standby position HP.

However, a specific method of stopping the edge binder 25 at the target position without returning the edge binder 25 to the origin position is not limited to the aforementioned example. As another example, the post-processing apparatus 3 may include a sensor that detects the arrival of the edge binder 25 at a target position determined in advance.

### Modification of Edge Binder

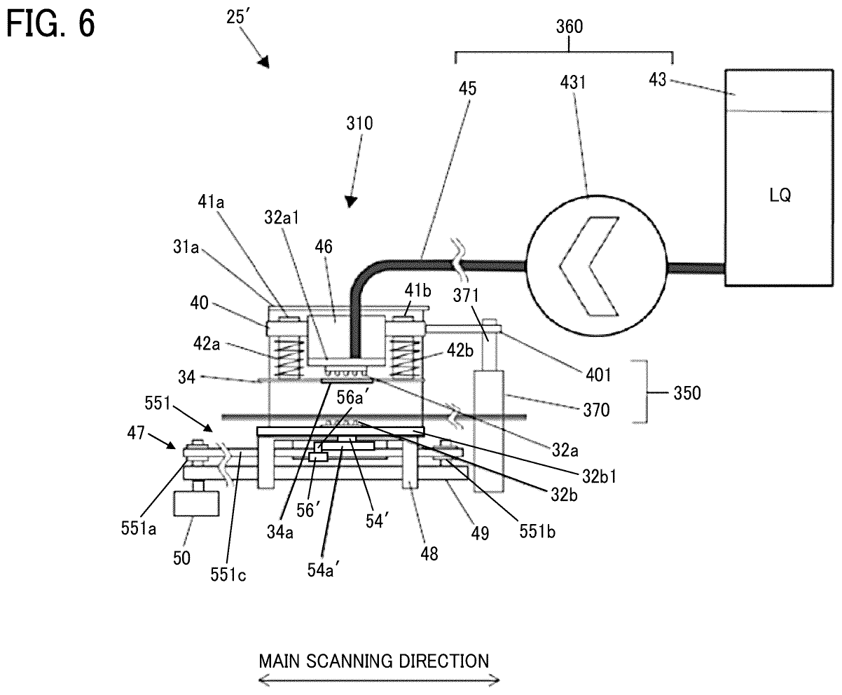

Referring now to FIGS. 6 to 8C, a description is given of an edge binder 25′ serving as a post-processing device, which is a modification of the edge binder 25 included in the post-processing apparatus 3. The edge binder 25′ is different from the edge binder 25 described above in that the liquid applier 31 and the crimper 32 are integrated together. In the following description, components like those of the edge binder 25 described above are denoted by like reference numerals, and redundant descriptions thereof may be omitted.

FIG. 6 is a schematic diagram of an edge binder 25′ as viewed from the upstream side in the conveyance direction.

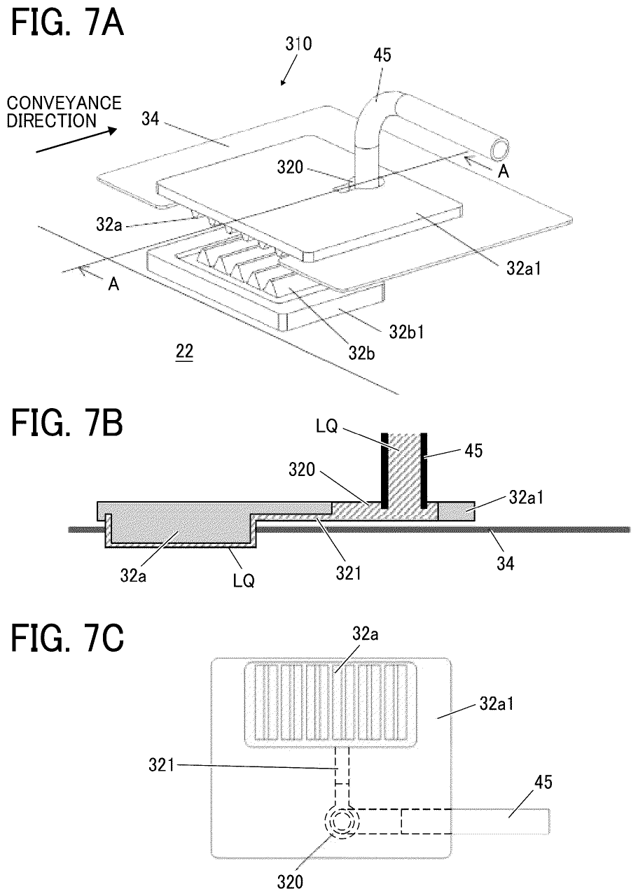

FIG. 7A is a perspective view of a liquid application crimper 310.

FIG. 7B is a cross-sectional view of the liquid application crimper 310 taken along line A-A in FIG. 7A.

FIG. 7C is a plan view of the upper crimping teeth 32a of FIG. 7A as viewed from where the lower crimping teeth 32b are disposed.

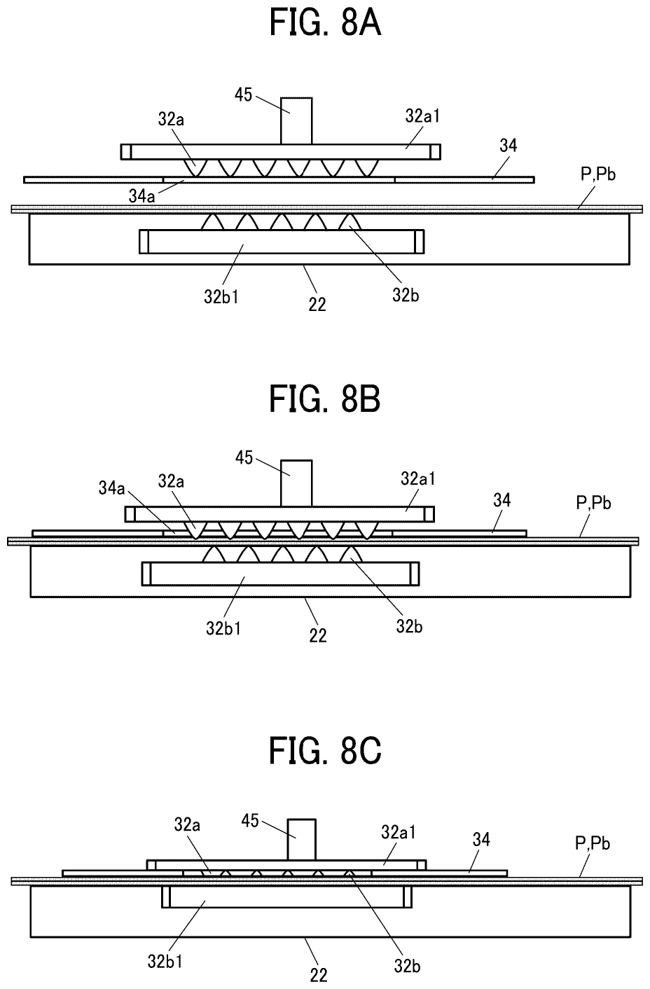

FIGS. 8A, 8B, and 8C are diagrams illustrating a liquid application operation and a crimp binding operation performed by the liquid application crimper 310, and schematic diagrams as viewed from the downstream side in the conveyance direction.

As illustrated in FIG. 6, the edge binder 25′ includes the liquid application crimper 310 in which the liquid applier 31 and the crimper 32 of the edge binder 25 according to the first embodiment are integrated together. The liquid application crimper 310 is disposed downstream from the internal tray 22 in the conveyance direction.

The liquid application crimper 310 applies a liquid LQ stored in the liquid storage tank 43 to the sheet P or the sheet bundle Pb stacked on the internal tray 22. The liquid application crimper 310 is enabled to move in the main scanning direction by the driving force that is transmitted from the edge binder movement motor 50 to the base 48 by the driving force transmission assembly 551. The liquid application crimper 310 includes the upper pressure plate 34, the upper crimping teeth 32a, the lower crimping teeth 32b, a liquid-application-crimper movement assembly 350, and a liquid supply assembly 360. The components of the liquid application crimper 310 are held by the liquid application frame 31a and the base 48. A liquid-application-crimper shaft 54′ provided with a drive transmission gear 54a′ is fixed to a bottom face of the liquid application frame 31a. The liquid-application-crimper shaft 54′ and the drive transmission gear 54a′ are held by the base 48 on which the liquid application frame 31a is disposed, so as to be rotatable in the forward and reverse directions. The drive transmission gear 54a′ engages with an output gear 56a′ of a liquid-application-crimper pivot motor 56′. The liquid application crimper 310 is enabled to rotate in the forward and reverse directions about the liquid-application-crimper shaft 54′ on the base 48 by driving force transmitted from the liquid-application-crimper pivot motor 56′ to the liquid-application-crimper shaft 54′ via the output gear 56a′ and the drive transmission gear 54a′.

The liquid-application-crimper movement assembly 350 moves the upper pressure plate 34, the base plate 40, and the upper crimping teeth 32a in conjunction with each other in the thickness direction of the sheet P or the sheet bundle Pb by an electric cylinder 370. The base plate 40 holds an upper-crimping-teeth holder 32a1 and the upper crimping teeth 32a via the joint 46. The base plate 40 movably holds the upper pressure plate 34 via the columns 41a and 41b. The base plate 40 is attached to an end of a rod 371 of the electric cylinder 370 via a connecter 401.

The columns 41a and 41b hold, by lower ends thereof, the upper pressure plate 34. The coil springs 42a and 42b are fitted around the columns 41a and 41b, respectively, between the base plate 40 and the upper pressure plate 34. The coil springs 42a and 42b bias the upper pressure plate 34 and the columns 41a and 41b in a direction away from the base plate 40.

The liquid supply assembly 360 includes the liquid storage tank 43, a liquid supply pump 431, and the liquid supplier 45. The liquid supply pump 431 supplies the liquid LQ via the liquid supplier 45 to a liquid reservoir 320 of the upper-crimping-teeth holder 32a1 as illustrated in FIG. 7A. The liquid supplier 45 is an elastic elongated member having a base end coupled to the liquid supply pump 431 and a distal end coupled to the liquid reservoir 320.

As illustrated in FIG. 7B, the upper crimping teeth 32a are integrated with the upper-crimping-teeth holder 32a1. The upper-crimping-teeth holder 32a1 includes the liquid reservoir 320 and a liquid supply passage 321 to supply the liquid LQ stored in the liquid reservoir 320 to the upper crimping teeth 32a. The surface of the upper crimping teeth 32a is subjected to a hydrophilic treatment so that the liquid LQ supplied through the liquid supply passage 321 uniformly spreads over the surface of the upper crimping teeth 32a. On the other hand, the portion of the upper-crimping-teeth holder 32a1 other than the upper crimping teeth 32a is subjected to a hydrophobic treatment so that the liquid LQ efficiently spreads over the surface of the upper crimping teeth 32a.

As illustrated in FIG. 6, the lower crimping teeth 32b are integrated with a lower-crimping-teeth holder 32b1, which is a part of the liquid application frame 31a. The lower crimping teeth 32b are attached to the base 48 via the lower-crimping-teeth holder 32b1.

Referring now to FIGS. 8A, 8B, and 8C, a description is given of the liquid application operation and the crimp binding operation by the liquid application crimper 310.

In the process of supplying the sheet P to the internal tray 22, as illustrated in FIG. 8A, the upper crimping teeth 32a and the lower crimping teeth 32b are separated from each other. When the sheet P is stacked on the internal tray 22, the electric cylinder 370 is contracted to move the upper crimping teeth 32a and the upper pressure plate 34 toward the sheet P. Then, as illustrated in FIG. 8B, the upper pressure plate 34 first contacts the sheet P, and then the upper crimping teeth 32a pass through the through hole 34a of the upper pressure plate 34 and contacts the sheet P. At this time, since the liquid LQ has spread over the surface of the upper crimping teeth 32a, the upper crimping teeth 32a is brought into contact with the sheet P to apply the liquid to the liquid application position on the sheet P. When the liquid application to the liquid application position is completed, the electric cylinder 370 is extended to separate the upper crimping teeth 32a and the upper pressure plate 34 from the sheet P. The aforementioned contact and separation operation of the upper crimping teeth 32a and the upper pressure plate 34 with respect to the sheet P corresponds to the liquid application operation, which is repeated on the sheets P constituting the sheet bundle Pb.

In response to reaching the number of the sheets P of the sheet bundle Pb stacked on the internal tray 22 to a given number, the electric cylinder 370 is further contracted to move the upper crimping teeth 32a toward the lower crimping teeth 32b. As illustrated in FIG. 8C, the upper crimping teeth 32a further moves toward the lower crimping teeth 32b with the sheet bundle Pb sandwiched between the upper crimping teeth 32a and the lower crimping teeth 32b. Thus, the upper crimping teeth 32a and the lower crimping teeth 32b press and deform the sheet bundle Pb to perform crimp binding on the sheet bundle Pb. In short, the crimp binding operation is performed.

### Description of Staple Binder

A detailed description is now given of the staple binder 155 having a function of executing staple binding.

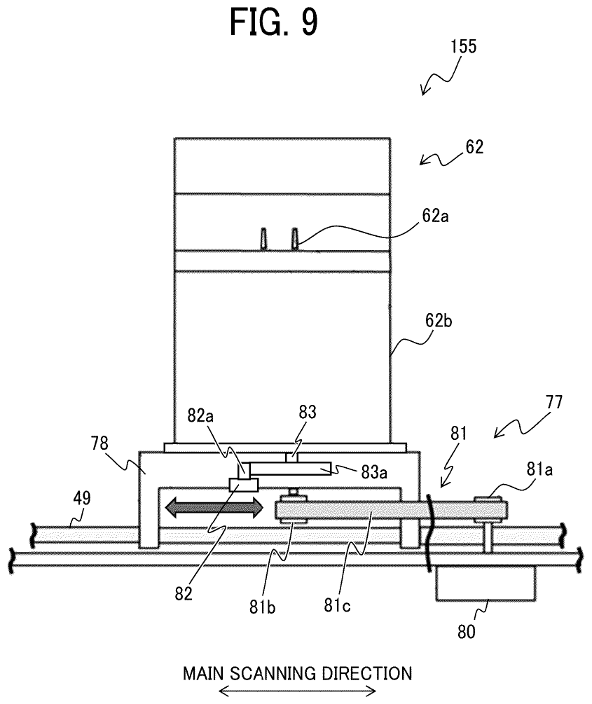

FIG. 9 is a schematic of the staple binder 155 as viewed from the upstream side in the conveyance direction.

The staple binder 155 includes a staple binder 62 that binds the sheet bundle Pb with a staple. The staple binder 62 is disposed downstream from the internal tray 22 in the conveyance direction and spaced apart from the edge binder 25 in the main scanning direction.

The staple binder 62 serving as a post-processing device has a configuration of performing so-called “staple binding” in which the sheet bundle Pb is bound with a staple. More particularly, the staple binder 62 includes a staple-part drive motor 62d (see FIG. 12) that drives a stapler 62a. The driving force of the staple-part drive motor 62d causes a staple loaded in the stapler 62a to penetrate through the sheet bundle Pb, so that the stapler 62a binds the sheet bundle Pb. Since the configuration of the staple binder 62 is already known, detailed description thereof is omitted.

As illustrated in FIG. 9, the staple binder 155 includes a staple-binder movement assembly 77. The staple-binder movement assembly 77 moves the staple binder 155 in the main scanning direction along a downstream end in the conveyance direction of the sheet P or the sheet bundle Pb stacked on the internal tray 22. The staple-binder movement assembly 77 includes, for example, a base 78, the guide shaft 49, a staple binder movement motor 80, and a driving force transmission assembly 81. The driving force transmission assembly 81 transmits driving force of the staple binder movement motor 80 to the base 78 via pulleys 81a and 81b and a timing belt 81c. A staple binder shaft 83 provided with a drive transmission gear 83a is fixed to a bottom face of a staple binding frame 62b that holds the components of the staple binder 62. The staple binder shaft 83 and the drive transmission gear 83a are held by the base 78 on which the staple binding frame 62b is disposed, so as to be rotatable in the forward and reverse directions. The drive transmission gear 83a engages with an output gear 82a of a stapler pivot motor 82. The staple binder 62 is enabled to rotate in the forward and reverse directions about the staple binder shaft 83 on the base 78 by driving force transmitted from the stapler pivot motor 82 to the staple binder shaft 83 via the output gear 82a and the drive transmission gear 83a.

The edge binder 25 and the staple binder 155 are supported by the common guide shaft 49. In other words, the edge-binder movement assembly 47 and the staple-binder movement assembly 77 move the edge binder 25 and the staple binder 155 in the main scanning direction along the common guide shaft 49. The edge-binder movement assembly 47 and the staple-binder movement assembly 77 can independently move the edge binder 25 and the staple binder 155.

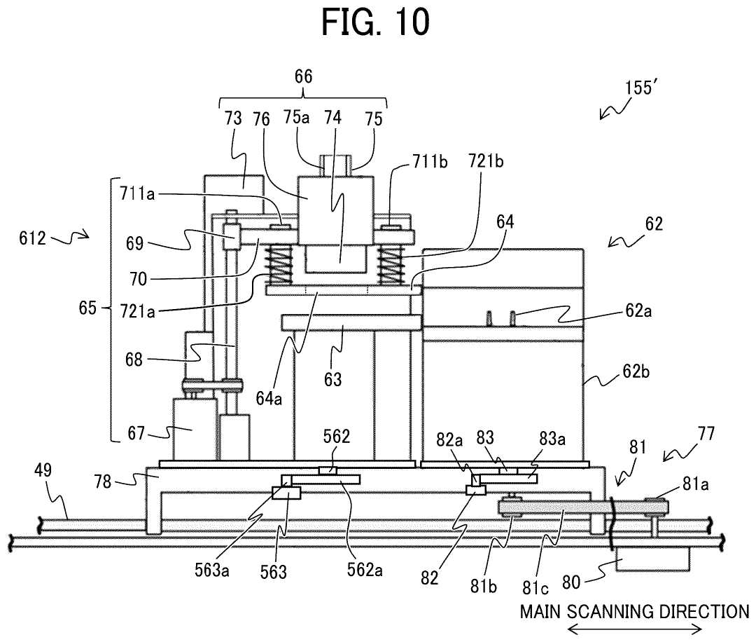

FIG. 10 illustrates a staple binder 155′ as a modification of the staple binder 155, and is a schematic diagram of the staple binder 155′ as viewed from the upstream side in the conveyance direction.

The staple binder 155′ is different from the staple binder 155 in that the staple binder 155′ includes a second liquid applier 612 in addition to the staple binder 62. As illustrated in FIG. 10, the staple binder 155′ includes the second liquid applier 612 and the staple binder 62. The second liquid applier 612 and the staple binder 62 are disposed downstream from the internal tray 22 in the conveyance direction and adjacent to each other in the main scanning direction.

The second liquid applier 612 executes “liquid application” of applying a liquid stored in a second liquid storage tank 73 to the sheet P or the sheet bundle Pb supported on the internal tray 22. A given area including a position at which liquid application is performed on the sheet P or the sheet bundle Pb by the second liquid applier 612 corresponds to a binding position to which staple binding is planned to be performed. As illustrated in FIG. 10, the second liquid applier 612 includes a second lower pressure plate 63, a second upper pressure plate 64 having a through hole 64a, a second liquid-applier movement assembly 65, and a second liquid application assembly 66. The second liquid-applier movement assembly 65 includes, for example, a second liquid-applier movement motor 67, a second trapezoidal screw 68, a second nut 69, a second base plate 70, second columns 711 (711a and 711b), and second coil springs 721 (721a and 721b). The second liquid application assembly 66 includes the second liquid storage tank 73, a second liquid application member 74, a third liquid supplier 75 around which a protector 75a is fitted, and a second joint 76. Since the second liquid application assembly 66 and the liquid application assembly 36 have common configurations, redundant descriptions thereof is omitted. Since the configuration of the staple binder 62 is like the configuration illustrated in FIG. 9, a detailed description thereof is omitted. Since the second liquid applier 612 and the liquid applier 31 illustrated in FIG. 3 have common pivot assemblies, redundant descriptions thereof is omitted.

As performed by the staple binder 155′ illustrated in FIG. 10, also in the staple binding, by performing the liquid application process on the sheets P, it is possible to loosen and soften the binding position to cause the staple to easily pass through the sheets P. As a result, the number of sheets to be bound per sheet bundle Pb can be increased as compared with a case where the staple binding is performed without performing liquid application.

### Configuration around Internal Tray

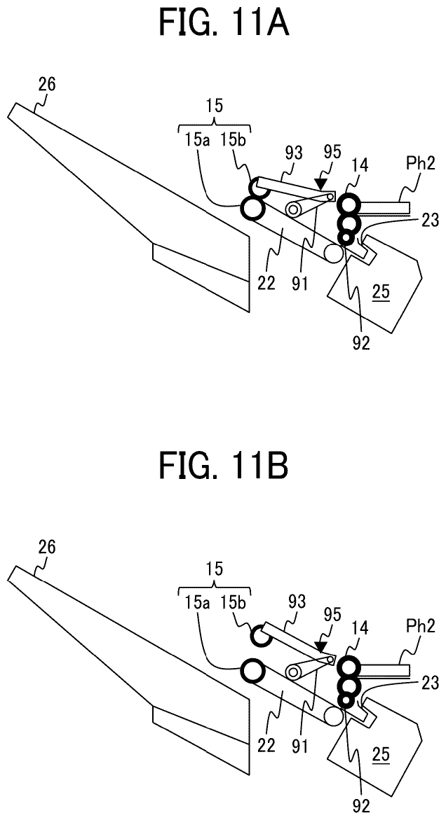

FIGS. 11A and 11B are enlarged views of a main part around the internal tray 22.

As illustrated in FIGS. 11A and 11B, the post-processing apparatus 3 includes, as components for causing the edge binder 25 to process the sheet bundle Pb: the conveyance roller pairs 14 and 15; the internal tray 22 (stacker); the end fence 23; the side fences 24L and 24R (see FIG. 2); the liquid applier 31 (liquid application device) and the crimper 32 (post-processing device) of the edge binder 25; the ejection tray 26 (ejection unit), the hitting roller 91; the return roller 92; an opening and closing guide plate 93; a guide plate pivot motor 94 (see FIG. 12); and a guide plate sensor 95 (detector).

The conveyance roller pairs 14 and 15, the hitting roller 91, and the return roller 92 are conveyor that convey the sheet P (sheet bundle Pb) at different positions on the second conveyance passage Ph2. More particularly, the conveyance roller pair 14 is an example of a first conveyor, the hitting roller 91 and the return roller 92 are examples of a second conveyor, and the conveyance roller pair 15 is an example of a third conveyor.

The conveyance roller pair 14 is disposed at a position where the sheet P on which an image is formed by the image forming apparatus 2 reaches before the conveyance roller pair 15. The conveyance roller pair 14 includes a drive roller and a driven roller arranged to face each other with the second conveyance passage Ph2 interposed therebetween. The conveyance roller pair 14 conveys the sheet P on which an image is formed by the image forming apparatus 2 toward the conveyance roller pair 15 along the second conveyance passage Ph2. The conveyance roller pair 14 also functions as a slide assembly that slides the sheet P on the second conveyance passage Ph2 in the width direction (main scanning direction) orthogonal to the conveyance direction.

The conveyance roller pair 15 is disposed at a position where the sheet P conveyed by the conveyance roller pair 14 reaches and between the internal tray 22 and the ejection tray 26. In other words, in the second conveyance passage Ph2, the conveyance roller pair 15 is disposed at a position where a conveyance passage from the conveyance roller pair 14 to the ejection tray 26 and a conveyance passage from the internal tray 22 to the ejection tray 26 merge. The conveyance roller pair 15 conveys the sheet P conveyed by the conveyance roller pair 14 or the sheet bundle Pb stacked on the internal tray 22 toward the ejection tray 26.

The conveyance roller pair 15 includes a drive roller 15a and a driven roller 15b. The drive roller 15a and the driven roller 15b are disposed to face each other with the second conveyance passage Ph2 interposed therebetween. The drive roller 15a is rotated by transmission of driving force of a motor. The driven roller 15b is driven with the rotation of the drive roller 15a. The conveyance roller pair 15 conveys the sheet P (sheet bundle Pb) toward the ejection tray 26 by rotating the drive roller 15a in a state where the sheet P (sheet bundle Pb) is nipped by the drive roller 15a and the driven roller 15b.

The opening and closing guide plate 93 (opening and closing guide member) is supported by a housing 4 (see FIGS. 1 and 2) of the post-processing apparatus 3 so as to be pivotable about a shaft extending in the main scanning direction. The driven roller 15b is rotatably supported at a pivot end of the opening and closing guide plate 93. The opening and closing guide plate 93 pivots by the driving force of the guide plate pivot motor 94 so as to bring the driven roller 15b into and out of contact with the drive roller 15a (in other words, to open and close the second conveyance passage Ph2 between the drive roller 15a and the driven roller 15b).

In other words, when the opening and closing guide plate 93 pivots in a first direction (clockwise in FIGS. 11A and 11B), as illustrated in FIG. 11B, the drive roller 15a and the driven roller 15b are separated from each other (an amount of opening of the second conveyance passage Ph2 increases). As a result, the conveyance roller pair 14 can slide the sheet P, and multiple sheets P can be stacked on the internal tray 22. On the other hand, when the opening and closing guide plate 93 pivots in a second direction (counterclockwise in FIGS. 11A and 11B) opposite to the first direction, as illustrated in FIG. 11A, the drive roller 15a and the driven roller 15b come into contact with each other (the amount of opening of the second conveyance passage Ph2 decreases). As a result, the sheet P (sheet bundle Pb) nipped by the drive roller 15a and the driven roller 15b can be ejected toward the ejection tray 26.

The guide plate sensor 95 detects a position of the opening and closing guide plate 93 (in other words, the amount of opening of the second conveyance passage Ph2) and outputs a detection signal indicating a detection result to the controller 100. For example, the guide plate sensor 95 outputs the detection signal when the amount of opening of the second conveyance passage Ph2 is less than a threshold, and stops outputting the detection signal when the amount of opening of the second conveyance passage Ph2 is greater than or equal to the threshold. The threshold here is set to, for example, a value corresponding to the thickness of the sheet bundle Pb assumed to be stacked on the internal tray 22.

An encoder sensor 96 outputs a number of pulse signals corresponding to an amount of rotation of the guide plate pivot motor 94 to the controller 100. The controller 100 counts the pulse signals output from the encoder sensor 96 to specify an amount of pivot of the opening and closing guide plate 93 (in other words, the amount of opening of the second conveyance passage Ph2).

The hitting roller 91 and the return roller 92 convey the sheet P conveyed by the conveyance roller pair 14 toward the internal tray 22 (in other words, the end fence 23). More particularly, in a state where the conveyance roller pair 15 opens the second conveyance passage Ph2, the hitting roller 91 and the return roller 92 switch back the sheet P entering between the drive roller 15a and the driven roller 15b and passing through the conveyance roller pair 14, to convey the sheet P toward the internal tray 22.

The conveyance roller pairs 14 and 15, the internal tray 22, the end fence 23, the side fences 24L and 24R, the edge binder 25, the staple binder 155, the hitting roller 91, the return roller 92, the opening and closing guide plate 93, the guide plate pivot motor 94, and the guide plate sensor 95 are accommodated in the housing 4 of the post-processing apparatus 3. On the other hand, the ejection tray 26 is supported by the outer surface of the housing 4. The housing 4 is provided with an ejection port for exposing the second conveyance passage Ph2 formed inside the housing 4 to the outside.

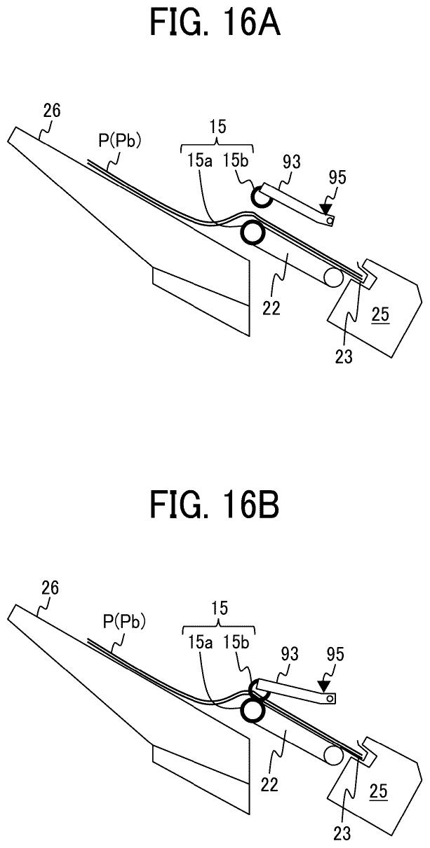

The ejection port is formed above the ejection tray 26. The conveyance roller pair 15 is disposed at a position where the conveyance roller pair 15 faces the ejection port. In other words, the sheet P (sheet bundle Pb) conveyed by the conveyance roller pair 15 is ejected to the ejection tray 26 through the ejection port. As illustrated in FIGS. 16A and 16B, a part of the sheet P (sheet bundle Pb) supported by the internal tray 22 passes through a space between the drive roller 15a and the driven roller 15b, and the ejection port, and is supported by the ejection tray 26.

### Control Block of Post-Processing Apparatus

FIG. 12 is a hardware configuration diagram of the post-processing apparatus 3. As illustrated in FIG. 12, the post-processing apparatus 3 has a configuration in which a central processing unit (CPU) 101, a random access memory (RAM) 102, a read only memory (ROM) 103, a hard disk drive (HDD) 104, and an interface (I/F) 105 are connected to each other via a common bus 109.

The CPU 101 is an arithmetic unit and controls the overall operation of the post-processing apparatus 3.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, for example, a control program stored in the ROM 103 and an information processing program (application program) loaded into the RAM 102 from a storage medium such as the HDD 104. Through the processing, a software control unit including various functional modules of the post-processing apparatus 3 is configured. Functional blocks that implement functions of the post-processing apparatus 3 are configured by combinations of the software control unit configured as described above and hardware resources mounted on the post-processing apparatus 3. In other words, the CPU 101, the RAM 102, the ROM 103, and the HDD 104 constitute the controller 100 (corresponding to a control unit) that controls the operation of the post-processing apparatus 3.

The I/F 105 is an interface that connects, to the common bus 109, the conveyance roller pairs 10, 11, 14, and 15, the switching member, the side fences 24L and 24R, the contact-separation motor 32d, the crimper pivot motor 56, the liquid applier movement motor 37, the liquid applier pivot motor 563, the edge binder movement motor 50, the staple-part drive motor 62d, the stapler pivot motor 82, the staple binder movement motor 80, the hitting roller 91, the return roller 92, the guide plate pivot motor 94, the movement sensor 40a, the liquid amount sensor 43a, the edge binding standby position sensor 51, the guide plate sensor 95, the encoder sensors 96 and 541, and an operation panel 110. The controller 100 controls, through the I/F 105, operations of the conveyance roller pairs 10, 11, 14, and 15, the switching member 20, the side fences 24L and 24R, the contact-separation motor 32d, the crimper pivot motor 56, the liquid applier movement motor 37, the liquid applier pivot motor 563, the edge binder movement motor 50, the staple-part drive motor 62d, the stapler pivot motor 82, the staple binder movement motor 80, the hitting roller 91, the return roller 92, and the guide plate pivot motor 94.

The controller 100 acquires detection results by the movement sensor 40a, the liquid amount sensor 43a, the edge binding standby position sensor 51, the guide plate sensor 95, and the encoder sensors 96 and 541. Although FIG. 12 illustrates only components related to the edge binder 25 that execute the edge binding and the staple binder 155, components related to the saddle binder 28 that executes the saddle stitching are similarly controlled by the controller 100.

As illustrated in FIG. 1, the image forming apparatus 2 includes the operation panel 110. The operation panel 110 includes an operation unit that receives input operation by an operator and a display (notification unit) that notifies the operator of information. The operation unit includes, for example, physical input buttons and a touch screen overlaid on a display. The operation panel 110 acquires information from the operator through the operation unit and provides the operator with information through the display. A specific example of the notification unit is not limited to the display and may be a light emitting diode (LED) lamp or a speaker. The operator includes a so-called “operator” who is in charge of manufacturing the post-processing apparatus 3 or maintenance of the post-processing apparatus 3 and a so-called “user” who uses the post-processing apparatus 3. The post-processing apparatus 3 may include the operation panel 110 similar to the above.

### Description of Binding

A description is given below of a flow of the binding executed by the edge binder 25 included in the post-processing apparatus 3.

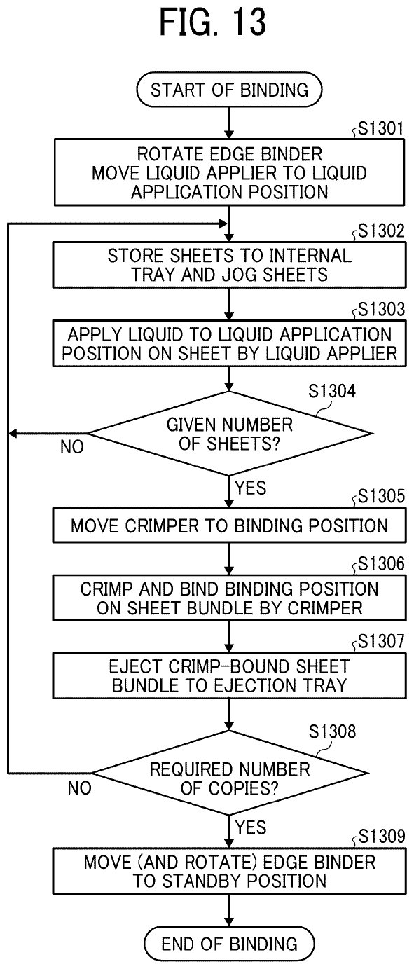

FIG. 13 is a flowchart of a binding.

FIGS. 14A, 14B, and 14C are diagrams illustrating positions of the liquid applier 31 and the crimper 32 during the binding.

With reference to FIGS. 13, 14A, 14B, and 14C, a description is given below of the changes in postures of the liquid applier 31 and the crimper 32.

The position (liquid application position) at which liquid application is performed on the sheet P or the sheet bundle Pb by the liquid applier 31 corresponds to the binding position to which crimp binding is planned to be performed by the crimper 32. For this reason, in the following description, the liquid application position and the binding position are denoted by the same reference sign.

For example, the controller 100 starts the binding illustrated in FIG. 13 at a timing when an execution instruction (hereinafter, referred to as a “binding instruction”) for the binding is acquired from the image forming apparatus 2.

The binding instruction includes, for example, the type of the sheet P (information affecting spread of a liquid, such as material and thickness), the number of sheets P constituting the sheet bundle Pb (hereinafter, referred to as “given number of sheets”), the number of sheet bundles Pb to be subjected to a binding (hereinafter, referred to as “requested number of copies”), the binding position on the sheet bundle Pb, and the binding posture of the edge binder 25. The liquid applier 31 and the crimper 32 are assumed to be in a parallel binding posture and positioned at the standby position HP (FIG. 14A) that is a position away from the sheet P stacked on the internal tray 22 in the width direction at the start of the binding.

When the posture indicated by the binding instruction is an “oblique binding posture”, the controller 100 drives the liquid applier pivot motor 563 and the crimper pivot motor 56 to rotate the liquid applier 31 and the crimper 32 constituting the edge binder 25 to the oblique binding posture. In the case of the “oblique binding posture”, only the crimper 32 may be rotated to the oblique binding posture while the liquid applier 31 may not be rotated. As a result, a drive assembly can be simplified as compared with a case where both the liquid applier 31 and the crimper 32 are rotated in the forward and reverse directions, and thus effects are exhibited of cost reduction, downsizing of the apparatus, and reduction of failures of devices.

On the other hand, when the posture indicated by the binding instruction is the “parallel binding posture”, the controller 100 omits the aforementioned operation of rotating the liquid applier 31 and the crimper 32 constituting the edge binder 25 to the oblique binding posture. As illustrated in FIG. 14B, in step S1301, the controller 100 drives the edge binder movement motor 50 to move the edge binder 25 in the main scanning direction so that the liquid applier 31 faces the liquid application position B1 indicated by the binding instruction. The controller 100 executes the process of step S1301 before the first sheet P is conveyed to the internal tray 22 by the conveyance roller pairs 10, 11, 14, and 15.

Subsequently, in step S1302, the controller 100 accommodates the sheet P on which an image has been formed by the image forming apparatus 2 in the internal tray 22 by rotating the conveyance roller pairs 10, 11, and 14, the hitting roller 91, and the return roller 92. In step S1302, the controller 100 also moves the side fences 24L and 24R to align the position, in the main scanning direction, of the sheet bundle Pb stacked on the internal tray 22. In short, the controller 100 performs so-called jogging.

Subsequently, in step S1303, the controller 100 causes the liquid applier 31 facing the liquid application position B1 to execute liquid application to the liquid application position B1 on the sheet P stacked on the internal tray 22 in the immediately preceding step S1302, on the basis of liquid application control data adjusted in advance. In other words, the controller 100 drives the liquid applier movement motor 37 to bring the liquid application member 44 into contact with the liquid application position B1 on the sheet P stacked on the internal tray 22 (FIG. 14B).

More particularly, the controller 100 retrieves, from the HDD 104, an amount of liquid application represented by a liquid application level corresponding to the type of the sheet P indicated by the binding instruction. Then, in step S1303, the controller 100 causes the liquid applier 31 to perform liquid application of the retrieved amount of liquid application to the binding position on the sheet P. In other words, the controller 100 causes the liquid applier 31 to perform liquid application of the amount of liquid application input through an amount-of-liquid-application setting screen, to the binding position on the sheet P stacked on the internal tray 22.

Subsequently, in step S1304, the controller 100 determines whether the number of sheets P accommodated in the internal tray 22 has reached the given number of sheets indicated by the binding instruction. When the controller 100 determines that the number of sheets P accommodated in the internal tray 22 has not reached the given number of sheets (No in step S1304), the controller 100 executes the process of steps S1302 and S1303 again. In other words, the controller 100 executes the process of steps S1302 to S1303 each time the sheet P is conveyed to the internal tray 22 by the conveyance roller pairs 10, 11, and 14, the hitting roller 91, and the return roller 92. However, the liquid application by the liquid applier 31 may be performed not only to all of the multiple sheets P of the sheet bundle Pb, but also to only some of the sheets P. For example, the controller 100 may cause the liquid applier 31 to perform liquid application to the sheet P at intervals of one in every “n” sheets.

When the controller 100 determines that the number of sheets P accommodated in the internal tray 22 has reached the given number of sheets (Yes in step S1304), in step S1305, as illustrated in FIG. 14C, the controller 100 drives the edge binder movement motor 50 to move the edge binder 25 in the main scanning direction so that the crimper 32 faces the binding position B1.

Subsequently, in step S1306, the controller 100 causes the crimper 32 to perform crimp binding on the sheet bundle Pb stacked on the internal tray 22. In step S1307, the controller 100 causes the conveyance roller pair 15 to output the sheet bundle Pb subjected to the crimp binding by the crimper 32 to the ejection tray 26. In other words, the controller 100 drives the contact-separation motor 32d to cause the upper crimping teeth 32a and the lower crimping teeth 32b to sandwich the binding position B1 on the sheet bundle Pb stacked on the internal tray 22. As a result, the sheet bundle Pb is pressed and deformed between the upper crimping teeth 32a and the lower crimping teeth 32b. Thus, the crimp binding is performed. Then, the controller 100 rotates the conveyance roller pair 15 to eject the sheet bundle Pb subjected to the crimp binding to the ejection tray 26.

The sheet bundle Pb stacked on the internal tray 22 has a crimping area (corresponding to the binding position B1) sandwiched between the upper crimping teeth 32a and the lower crimping teeth 32b in step S1306. The crimping area overlaps a liquid application area (corresponding to the liquid application position B1) contacted by the end of the liquid application member 44 in step S1303. In other words, the crimper 32 performs crimp binding on an area to which the liquid has been applied by the liquid applier 31 on the sheet bundle Pb stacked on the internal tray 22. The crimping area sandwiched by the upper crimping teeth 32a and the lower crimping teeth 32b does not have to completely overlap the liquid application area contacted by the end of the liquid application member 44, and can obtain a sufficient binding strength even when the crimping area partially overlaps the liquid application area.

Subsequently, in step S1308, the controller 100 determines whether the number of the ejected sheet bundles Pb has reached the requested number of copies indicated by the binding instruction. When the controller 100 determines that the number of the ejected sheet bundles Pb has not reached the requested number of copies (No in step S1308), the controller 100 executes the process of step S1302 and the following steps again. In other words, in the case of No in step S1308, the controller 100 repeats the process of steps S1302 to S1307 until the number of sheet bundles Pb ejected to the ejection tray 26 reaches the requested number of copies.

Then, when the controller 100 determines that the number of sheet bundles Pb ejected to the ejection tray 26 has reached the requested number of copies (Yes in step S1308), in step S1309, the controller drives the edge binder movement motor 50 to move the edge binder 25 to the standby position HP as illustrated in FIG. 14A. When the posture indicated by the binding instruction is the “oblique binding posture”, in step S1309, the controller 100 also drives the liquid applier pivot motor 563 and the crimper pivot motor 56 to rotate the liquid applier 31 and the crimper 32 to the parallel binding posture. On the other hand, when the posture indicated by the binding instruction is the “parallel binding posture”, the controller 100 omits the operation of rotating the liquid applier 31 and the crimper 32 to the parallel binding posture. As a result, the liquid applier 31 and the crimper 32 return to the standby position HP in FIG. 14A. Note that, in steps S1301 and S1309, the execution order of the movement in the main scanning direction and the rotation in the forward and reverse directions of the liquid applier 31 and the crimper 32 is not limited to the aforementioned order and may be reversed.

### Binding in Which Foreign Matter Is Prevented From Being Mixed

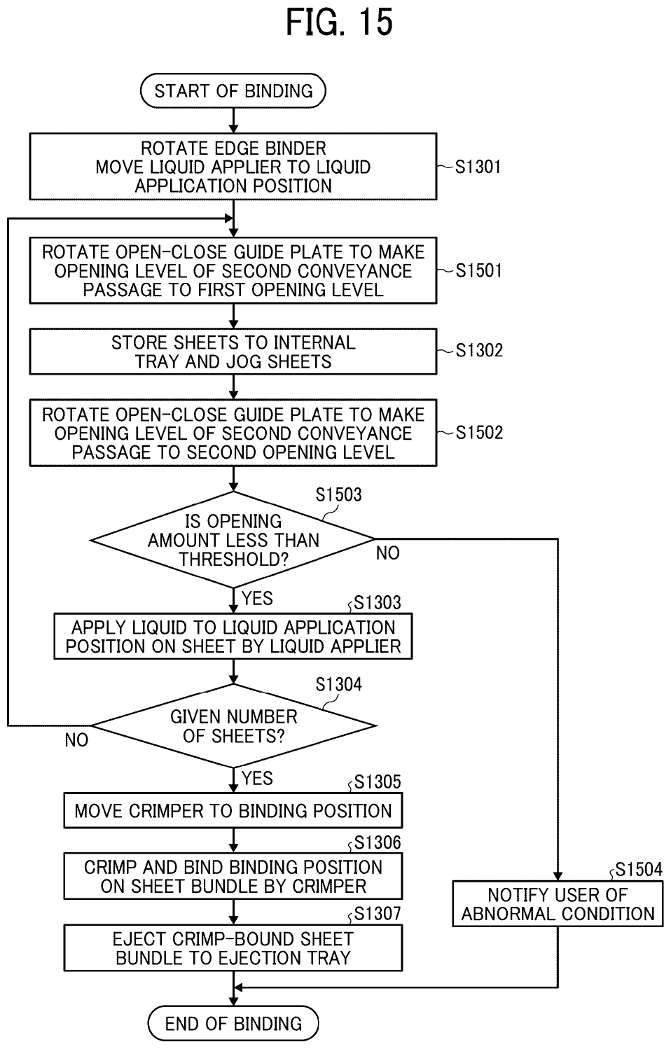

FIG. 15 is a flowchart of a binding in which foreign matter is prevented from being mixed.

FIGS. 16A and 16B are diagrams illustrating states of the conveyance roller pair 15 in steps S1501 and S1503 of FIG. 15.

The same step numbers are assigned to executing steps common to those in FIG. 13, and description thereof is omitted. In FIG. 15, illustration is omitted of steps S1308 to S1309 in FIG. 13, but the process may be executed.

In step S1302 of FIG. 13 repeatedly executed, it is necessary to separate the drive roller 15a and the driven roller 15b from each other to open the second conveyance passage Ph2 in order to stack the multiple sheets P on the internal tray 22. However, when the conveyance roller pair 15 opens the second conveyance passage Ph2, there is a possibility that foreign matter enters the inside of the housing 4 from the outside of the housing 4 through the ejection port. The foreign matter having entered the housing 4 may reach the edge binder 25 along the internal tray 22 inclined downward from the conveyance roller pair 15 side toward the end fence 23 side.

When the foreign matter is sandwiched between the lower pressure plate 33 and the upper pressure plate 34 at the time of applying the liquid to the sheet P, the liquid applier 31 may be damaged. Similarly, when the foreign matter is sandwiched between the upper crimping teeth 32a and the lower crimping teeth 32b at the time of binding the sheet bundle Pb, the crimper 32 may be damaged. Thus, in FIG. 15, the process of steps S1501 to S1504 is added to the binding illustrated in FIG. 13. More particularly, the controller 100 repeatedly executes the process of steps S1501, S1302, S1502, S1503, and S1303 in this order until the number of sheets P stacked on the internal tray 22 reaches the given number of sheets.

First, in step S1501, when stacking the sheet P on the internal tray 22 (in other words, before step S1302), the controller 100 causes the opening and closing guide plate 93 to pivot in the first direction to set the amount of opening of the second conveyance passage Ph2 to a first amount of opening as illustrated in FIG. 16A. More particularly, the controller 100 increases the amount of opening of the second conveyance passage Ph2 by the opening and closing guide plate 93 to the first amount of opening after the leading end of the sheet P reaches the conveyance roller pair 14 and before the leading end of the sheet P reaches the conveyance roller pair 15. The first amount of opening is set to a value at which the sheet P newly conveyed by the conveyance roller pair 14 can enter between the drive roller 15a and the driven roller 15b in addition to one or more sheets P stacked on the internal tray 22.

The first amount of opening may be a fixed value determined in advance or a variable value. For example, in step S1501, which is repeatedly executed, the controller 100 may change the first amount of opening in accordance with the number of sheets P stacked on the internal tray 22. It is sufficient that the controller 100 sets the first amount of opening by “the first amount of opening=the minimum value of the first amount of opening+the sum of thicknesses of the sheets P stacked on the internal tray 22”, for example.

In other words, it is sufficient that the controller 100 decreases the first amount of opening as the number of sheets P stacked on the internal tray 22 is smaller, and increases the first amount of opening as the number of sheets P stacked on the internal tray 22 is larger. In other words, in step S1501, which is repeatedly executed, it is sufficient that the controller 100 gradually (more particularly, by the thickness of the sheet P,) increases the amount of opening of the second conveyance passage Ph2.

Subsequently, in step S1502, when causing the liquid applier 31 to apply the liquid to the sheet P (in other words, after step S1302 and before step S1303), the controller 100 causes the opening and closing guide plate 93 to pivot in the second direction to set the amount of opening of the second conveyance passage Ph2 to the second amount of opening as illustrated in FIG. 16B. More particularly, the controller 100 decreases the amount of opening of the second conveyance passage Ph2 by the opening and closing guide plate 93 to the second amount of opening after the hitting roller 91 and the hitting roller 91 that have conveyed the sheet P to the internal tray 22 stop (more particularly, after the jogging by the side fences 24L and 24R is finished) and before the liquid applier 31 applies the liquid. The second amount of opening is set to a value smaller than the first amount of opening in step S1501 that is most recently executed. More preferably, the second amount of opening is set to a value with which the drive roller 15a and the driven roller 15b can nip and convey the sheet P (sheet bundle Pb).

The second amount of opening may be a fixed value determined in advance or a variable value. For example, in step S1502, which is repeatedly executed, the controller 100 may change the second amount of opening in accordance with the number of sheets P stacked on the internal tray 22. It is sufficient that the controller 100 sets the second amount of opening by “the second amount of opening=the minimum value of the second amount of opening+the sum of thicknesses of the sheets P stacked on the internal tray 22”, for example.

In other words, it is sufficient that the controller 100 decreases the second amount of opening as the number of sheets P stacked on the internal tray 22 is smaller, and increases the second amount of opening as the number of sheets P stacked on the internal tray 22 is larger. In other words, in step S1502, which is repeatedly executed, it is sufficient that the controller 100 gradually (more particularly, by the thickness of the sheet P,) increases the amount of opening of the second conveyance passage Ph2. The second amount of opening in this case is set to a value corresponding to the thickness of one or more sheets P stacked on the internal tray 22.

Subsequently, in step S1503, the controller 100 determines whether the amount of opening of the second conveyance passage Ph2 is less than the threshold on the basis of whether the detection signal is output from the guide plate sensor 95. Then, when the amount of opening of the second conveyance passage Ph2 is less than the threshold (the detection signal is output from the guide plate sensor 95) (Yes in step S1503), the controller 100 executes the process of step S1303 and the following steps. On the other hand, when the amount of opening of the second conveyance passage Ph2 is greater than or equal to the threshold (the detection signal is not output from the guide plate sensor 95) (No in step S1503), in step S1504, the controller 100 does not execute the process of step S1303 and the following steps (in other words, does not cause the liquid applier 31 to apply the liquid to the sheet P), and performs notification of an abnormality through the operation panel 110, and ends the binding in the middle. In step S1504, for example, it is sufficient to notify that foreign matter is mixed between the drive roller 15a and the driven roller 15b.

### Operation and Effect of Embodiment

According to the above embodiment, when the post-processing is executed by the edge binder 25, a time for separating the drive roller 15a and the driven roller 15b (in other words, a time for opening the second conveyance passage Ph2) can be shortened, so that it is possible to prevent foreign matter from being mixed into the housing 4. As a result, post-processing (edge binding) can be appropriately performed, and damage to the components can be prevented.

According to the above embodiment, by changing each of the first amount of opening and the second amount of opening in accordance with the number of sheets P stacked on the internal tray 22, it is possible to shorten a pivot time of the opening and closing guide plate 93. Thus, productivity of the post-processing apparatus 3 can be improved.

Furthermore, according to the above embodiment, after the guide plate sensor 95 detects that the second conveyance passage Ph2 is closed, the liquid applier 31 is caused to apply the liquid to the sheet P. As a result, even if foreign matter is mixed in during a short time while the second conveyance passage Ph2 is opened, it is possible to prevent damage to the edge binder 25 caused by pressing the foreign matter with the lower pressure plate 33 and the upper pressure plate 34 (or the upper crimping teeth 32a and the lower crimping teeth 32b). However, the process in steps S1503 to S1504 can be omitted.

The control method described above may be implemented by, for example, a program. In other words, the control method may be executed by causing an arithmetic device, a storage device, an input device, an output device, and a control device to operate in cooperation with each other on the basis of a program. In addition, the program may be written in, for example, a storage device or a storage medium and distributed, or may be distributed through, for example, an electric communication line.

The present invention is not limited to specific embodiments described above, and numerous additional modifications and variations are possible in light of the teachings within the technical scope of the appended claims. The above-described embodiments are some examples, and various modifications can be practiced from such examples by those skilled in the art. Such modifications are also included in the technical scope as set forth in the claims. Aspects of the present invention are, for example, as follows.

### Aspect 1

In Aspect 1, a medium processing apparatus includes a stacker, a liquid applier, a post-processing device, an ejection unit, a guide, and circuitry. The stacker stacks multiple media including a medium. The liquid applier applies liquid to at least one of the multiple media on the stacker. The post-processing device performs a given process on the multiple media to which the liquid is applied by the liquid applier. The ejection unit stacks the multiple media on which the given process is performed by the post-processing device. The guide opens and closes a conveyance passage in which the medium passes from the stacker to the ejection unit. The circuitry is to control operations of the liquid applier, the post-processing device, and the guide, cause the guide to set an opening amount of the conveyance passage to a first opening amount when stacking the medium on the stacker, and cause the guide to set the opening amount of the conveyance passage to a second opening amount smaller than the first opening amount when causing the liquid applier to apply the liquid to the medium.

### Aspect 2

In Aspect 2, in the medium processing apparatus of Aspect 1, the circuitry is further to change the first opening amount according to a number of the multiple media on the stacker, when stacking the medium on the stacker.

### Aspect 3

In Aspect 3, in the medium processing apparatus of Aspect 1 or Aspect 2, the circuitry is further to change the second opening amount according to a number of the multiple media on the stacker, when causing the liquid applier to apply the liquid to the medium.

### Aspect 4

In Aspect 4, the medium processing apparatus of any one of Aspects 1 to 3 further includes a detector to detect the opening amount of the conveyance passage by the guide. The circuitry is further to prevent the liquid applier from applying the liquid to the medium, when the amount of opening detected by the detector is greater than or equal to a threshold according to a thickness of the multiple media to be stacked on the stacker.

### Aspect 5

In Aspect 5, the medium processing apparatus of any one of Aspects 1 to 4 further includes multiple conveyors to convey the medium at different positions of the conveyance passage. One of the multiple conveyors nips the multiple media on the stacker and conveys the multiple media toward the ejection unit by a drive roller and a driven roller disposed to face the drive roller with the conveyance passage interposed between the drive roller and the driven roller. The guide supports the driven roller at a pivot end and pivots to open and close the conveyance passage.

### Aspect 6

In Aspect 6, in the medium processing apparatus of Aspect 5, the multiple conveyors include a first conveyor, a second conveyor, and a third conveyor. The second conveyor conveys the medium conveyed by the first conveyor toward the stacker. The third conveyor includes the drive roller and the driven roller. The third conveyor conveys the multiple media on the stacker toward the ejection unit. The circuitry is further to cause the guide to set the opening amount of the conveyance passage to the first opening amount, after a leading end of the medium reaches the first conveyor and before the leading end of the medium reaches the third conveyor, and cause the guide to set the opening amount of the conveyance passage to the second opening amount, after the second conveyor that has conveyed the medium to the stacker stops and before the liquid applier applies the liquid.

### Aspect 7

In Aspect 7, an image forming system includes an image forming apparatus to form an image on a medium, and the medium processing apparatus of any one of Aspects 1 to 6.

### Aspect 8

In Aspect 8, a medium processing apparatus includes a stacker, a liquid applier, a post-processor, an ejector, a guide, and circuitry. The stacker stacks multiple media including a medium. The liquid applier applies liquid to at least one of the multiple media on the stacker. The post-processor performs a given process on the multiple media to which the liquid has been applied by the liquid applier. The ejector ejects the multiple media on which the given process is performed by the post-processor. The guide opens and closes a conveyance passage to guide the medium from the stacker to the ejector. The circuitry is to control the guide to open the conveyance passage to a first opening amount to stack the medium on the stacker, and control the guide to open the conveyance passage to a second opening amount smaller than the first opening amount to control the liquid applier to apply the liquid to the medium.

### Aspect 9

In Aspect 9, in the medium processing apparatus of Aspect 8, the circuitry is further to control the guide to change the first opening amount according to a number of the multiple media on the stacker to stack the medium on the stacker.

### Aspect 10

In Aspect 10, in the medium processing apparatus of Aspect 8 or Aspect 9, the circuitry is further to control the guide to change the second opening amount according to a number of the multiple media on the stacker to control the liquid applier to apply the liquid applier to the medium.

### Aspect 11

In Aspect 11, the medium processing apparatus of any one of Aspects 8 to 10 further includes a detector to detect an opening amount of the conveyance passage opened by the guide. The circuitry is further to stop the liquid applier from applying the liquid to the medium, when the opening amount detected by the detector is greater than or equal to a threshold corresponding to a thickness of the multiple media to be stacked on the stacker.

### Aspect 12

In Aspect 12, the medium processing apparatus of any one of Aspects 8 to 11 further includes multiple conveyors at different positions in the conveyance passage to convey the medium. The multiple conveyors includes a drive roller, and a driven roller facing the drive roller with the conveyance passage interposed between the drive roller and the driven roller. The drive roller and the driven roller are to nip the multiple media on the stacker, and convey the multiple media toward the ejector. The guide has a pivot to support and pivot the driven roller to open and close the conveyance passage.

### Aspect 13

In Aspect 13, in the medium processing apparatus of Aspect 12, the multiple conveyors include a first conveyor, a second conveyor, and a third conveyor. The first conveyor conveys the medium along the conveyance passage. The second conveyor conveys the medium conveyed by the first conveyor toward the stacker. The third conveyor includes the drive roller and the driven roller. The third conveyor conveys the multiple media on the stacker toward the ejector. The circuitry is further to control the guide to open the conveyance passage to the first opening amount, after a leading end of the medium reaches the first conveyor and before the leading end of the medium reaches the third conveyor, and control the guide to open the conveyance passage to the second opening amount, after the second conveyor stops conveying the medium after a conveyance of the medium to the stacker, and before the liquid applier applies the liquid.

### Aspect 14

In Aspect 14, an image forming system includes an image forming apparatus to form an image on a medium, and the medium processing apparatus of any one of Aspects 8 to 13.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a stacker to stack multiple media including a medium;
a liquid applier to apply liquid to at least one of the multiple media on the stacker;
a post-processor to perform a given process on the multiple media to which the liquid has been applied by the liquid applier;
an ejector to eject the multiple media on which the given process is performed by the post-processor;
a guide to open and close a conveyance passage to guide the medium from the stacker to the ejector; and
circuitry configured to:
control the guide to open the conveyance passage to a first opening amount to stack the medium on the stacker; and
control the guide to open the conveyance passage to a second opening amount smaller than the first opening amount to control the liquid applier to apply the liquid to the medium.

2. The medium processing apparatus according to claim 1,
wherein the circuitry is further configured to control the guide to change the first opening amount according to a number of the multiple media on the stacker to stack the medium on the stacker.

3. The medium processing apparatus according to claim 1,
wherein the circuitry is further configured to control the guide to change the second opening amount according to a number of the multiple media on the stacker to control the liquid applier to apply the liquid applier to the medium.

4. The medium processing apparatus according to claim 1, further comprising a detector to detect an opening amount of the conveyance passage opened by the guide,
wherein the circuitry is further configured to stop the liquid applier from applying the liquid to the medium,
when the opening amount detected by the detector is greater than or equal to a threshold corresponding to a thickness of the multiple media to be stacked on the stacker.

5. The medium processing apparatus according to claim 1, further comprising multiple conveyors at different positions in the conveyance passage to convey the medium,
wherein the multiple conveyors includes:
a drive roller; and
a driven roller facing the drive roller with the conveyance passage interposed between the drive roller and the driven roller, the drive roller and the driven roller to:
nip the multiple media on the stacker; and
convey the multiple media toward the ejector, and
the guide has a pivot to support and pivot the driven roller to open and close the conveyance passage.

6. The medium processing apparatus according to claim 5,
wherein the multiple conveyors include:
a first conveyor to convey the medium along the conveyance passage;
a second conveyor to convey the medium conveyed by the first conveyor toward the stacker; and
a third conveyor including the drive roller and the driven roller,
the third conveyor conveys the multiple media on the stacker toward the ejector, and
the circuitry is further configured to:
control the guide to open the conveyance passage to the first opening amount, after a leading end of the medium reaches the first conveyor and before the leading end of the medium reaches the third conveyor, and
control the guide to open the conveyance passage to the second opening amount, after the second conveyor stops conveying the medium after a conveyance of the medium to the stacker, and before the liquid applier applies the liquid.

7. An image forming system comprising:
an image forming apparatus to form an image on a medium; and
the medium processing apparatus according to claim 1.
